(19) United States
(12) Patent Application Publication
(10) Pub. No.: US 2022/0204733 A1
(43) Pub. Date: Jun. 30, 2022

(54) FLAME-RETARDANT RESIN COMPOSITION AND CABLE USING THE SAME

(71) Applicant: Fujikura Ltd., Tokyo (JP)

(72) Inventors: Yusuke Yamaki, Chiba (JP); Ryo Watanabe, Chiba (JP)

(73) Assignee: Fujikura Ltd., Tokyo (JP)

(21) Appl. No.: 17/606,948

(22) PCT Filed: Jun. 22, 2020
(86) PCT No.: PCT/JP2020/024427

§ 371 Date: Oct. 27, 2021

(30) Foreign Application Priority Data
Jul. 20, 2019 (JP) 2019-134190

(51) Int. Cl. C08L 23/04; H01B 7/295; G02B 6/44

(52) U.S. Cl. CPC C08L 23/04; H01B 7/295; C08L 2203/202; C08L 2205/03; C08L 2201/02; G02B 6/443

(57) ABSTRACT

A flame-retardant resin composition includes a base resin, a silicone compound in an amount of 1 to 12 parts by mass to 100 parts by mass of the base resin, a fatty acid-containing compound in an amount of 1 to 10 parts by mass to 100 parts by mass of the base resin, and a filler in an amount of 10 to 80 parts by mass to 100 parts by mass of the base resin. The base resin includes 10 to 90 mass % of a low-density polyethylene, 10 to 90 mass % of a low-density polyethylene-based thermoplastic elastomer, and 0 to 80 mass % of a modified polyethylene. The filler is composed of at least one selected from the group consisting of calcium carbonate and a silicate compound.

### TECHNICAL FIELD

One or more embodiments of the present invention relate to a flame-retardant resin composition and a cable using the same.

### BACKGROUND

So-called flame-retardant resin compositions are widely used for cable coatings, cable sheaths, tubes, tapes, packaging materials, building materials, and the like.

As such a flame-retardant resin composition, known is a flame-retardant resin composition in which calcium carbonate particles, a silicone compound and a fatty acid-containing compound are blended to abase resin containing, for example, a high-density polyethylene, a low-density polyethylene, and a modified polyolefin compound (see Patent Document 1 below).
Patent Document 1: WO2016/031789

However, although the flame-retardant resin composition described in the above-mentioned Patent Document 1 has excellent flame retardancy, mechanical properties and easy tearing properties, it has room for improvement in flexibility.

Therefore, there has been a need for a flame-retardant resin composition having excellent flame retardancy, easy tearing properties, flexibility and mechanical properties.

### SUMMARY

One or more embodiments of the present invention provide a flame-retardant resin composition having excellent flame retardancy, easy tearing properties, flexibility and mechanical properties, and a cable using the same.

One or more embodiments of the present invention are described below.

That is, one or more embodiments of the present invention provide a flame-retardant resin composition including a base resin, a silicone compound blended in an amount of 1 to 12 parts by mass to 100 parts by mass of the base resin, a fatty acid-containing compound blended in an amount of 1 to 10 parts by mass to 100 parts by mass of the base resin, and a filler blended in an amount of 10 to 80 parts by mass to 100 parts by mass of the base resin, in which a content of a low-density polyethylene in the base resin is 10 to 90 mass %, a content of a low-density polyethylene-based thermoplastic elastomer in the base resin is 10 to 90 mass %, and a content of a modified polyethylene in the base resin is 0 to 80 mass %, and the filler is composed of at least one selected from the group consisting of calcium carbonate and a silicate compound.

The flame-retardant resin composition of one or more embodiments of the present invention can have excellent flame retardancy, easy tearing properties, flexibility and mechanical properties.

The above-mentioned effect is obtained in the flame-retardant resin composition of the present invention, for the reason as follows:

That is, when the amounts of the silicone compound, the fatty acid-containing compound and the filler blended to the base resin are set to a predetermined value or more and the filler is composed of at least one selected from the group consisting of calcium carbonate and the silicate compound, a barrier layer composed mainly of the silicone compound, the fatty acid-containing compound, the filler and a decomposition product thereof is formed on the surface of the base resin at the time of combustion of the flame-retardant resin composition, and combustion of the base resin is suppressed. Therefore, it is considered that excellent flame retardancy is secured. In addition, since the base resin contains the low density polyethylene, the low density polyethylene-based thermoplastic elastomer, and optionally the modified polyethylene, and the content of the low density polyethylene-based thermoplastic elastomer in the base resin is set to a predetermined range, cracks can be easily formed in the base resin itself with a smaller force at the time of tearing. Further, since an adhesive force between the filler and the base resin is small, the tearing can be easily performed when the amount of the filler to the base resin becomes a predetermined value or more and a crack formed in the base resin reaches an interface between the filler and the base resin. Therefore, it is considered that the flame-retardant resin composition has excellent easy tearing properties. Further, since the amount of the filler blended to the base resin is a predetermined value or less, the base resin contains the low-density polyethylene having large hardness at a predetermined content or less and contains the low-density polyethylene-based thermoplastic elastomer having large flexibility at a predetermined content or more, it is considered that the flame-retardant resin composition has excellent flexibility. Further, since the flame-retardant resin composition contains the silicone compound, the fatty acid-containing compound and the filler, it is possible to impart to the flame-retardant resin composition a flame retardancy equivalent to that of a flame-retardant resin composition containing a metal hydroxide with a smaller amount. Therefore, it is considered that the interface of the base resin with the silicone compound, the fatty acid-containing compound and the filler is reduced, and as a result, the flame-retardant resin composition has excellent mechanical properties.

The flame-retardant resin composition may further contain a hindered amine compound in an amount of 0.1 to 8 parts by mass to 100 parts by mass of the base resin.

In this case, the flame retardancy of the flame-retardant resin composition can be further improved as compared to a case where the flame-retardant resin composition further contains the hindered amine compound in an amount of less than 0.1 parts by mass to 100 parts by mass of the base resin. Further, mechanical properties of the flame-retardant resin composition can be further improved as compared to a case where the flame-retardant resin composition further contains the hindered amine compound in an amount exceeding 8 parts by mass to 100 parts by mass of the base resin.

In the flame-retardant resin composition, the content of the modified polyethylene in the base resin may be 5 mass % or more.

In this case, the mechanical properties of the flame-retardant resin composition can be further improved.

In the flame-retardant resin composition, the content of the modified polyethylene in the base resin may be 20 mass % or less.

In this case, easy tearing properties of the flame-retardant resin composition can be further improved as compared to a case where the content of the modified polyethylene in the base resin exceeds 20 mass %.

In the flame-retardant resin composition, the content of the low-density polyethylene in the base resin may be 40 to 85 mass %, and that the content of the low-density polyethylene-based thermoplastic elastomer in the base resin may be 15 to 60 mass %.

In this case, easy tearing properties of the flame-retardant resin composition can be further improved as compared to a case where the content of the low-density polyethylene in the base resin is less than 40 mass %. Further, the flexibility of the flame-retardant resin composition can be further improved as compared to a case where the content of the low-density polyethylene in the base resin exceeds 85 mass %, and a case where the content of the low-density polyethylene-based thermoplastic elastomer in the base resin is less than 15 mass %. In addition, blocking resistance of the flame-retardant resin composition can be further improved as compared to a case where the content of the low-density polyethylene-based thermoplastic elastomer in the base resin exceeds 60 mass %.

In the flame-retardant resin composition, the silicone compound may be blended in an amount of 3 to 12 parts by mass to 100 parts by mass of the base resin, and the fatty acid-containing compound be blended in an amount of 3 to 10 parts by mass to 100 parts by mass of the base resin.

In this case, the flame retardancy of the flame-retardant resin composition can be further improved as compared to a case where the amounts of the silicone compound and the fatty acid-containing compound blended to 100 parts by mass of the base resin are less than 3 parts by mass, respectively. The mechanical properties of the flame-retardant resin composition can be further improved, as compared to a case where the amount of the silicone compound blended to 100 parts by mass of the base resin exceeds 12 parts by mass, and a case where the amount of the fatty acid-containing compound blended to 100 parts by mass of the base resin exceeds 10 parts by mass.

One or more embodiments of the present invention provide a cable including a transmission medium composed of a conductor or an optical fiber, and an insulator covering the transmission medium, in which the insulator includes an insulating part composed of the flame-retardant resin composition described above.

According to the cable of one or more embodiments of the present invention, the insulator includes the insulating part composed of the flame-retardant resin composition described above, and the flame-retardant resin composition described above has excellent flame retardancy, easy tearing properties, flexibility and mechanical properties. For this reason, the cable of one or more embodiments of the present invention can have excellent flame retardancy, flexibility and mechanical properties, and allows tearing or stripping of the cable to be easily performed.

According to one or more embodiments of the present invention, provided are a flame-retardant resin composition having excellent flame retardancy, easy tearing properties, flexibility and mechanical properties, and a cable using the same.

### BRIEF DESCRIPTION OF DRAWINGS

FIG. 1 is a partial side view showing a first embodiment of a cable of the present invention;

FIG. 2 is a cross-sectional view taken along line II-II of FIG. 1; and

FIG. 3 is a cross-sectional view showing a second embodiment of the cable of the present invention.

### DETAILED DESCRIPTION

Hereinafter, embodiments of the present invention will be described in detail.

<Flame-Retardant Resin Composition>

The flame-retardant resin composition of one or more embodiments of the present invention includes a base resin, a silicone compound, a fatty acid-containing compound and a filler. The silicone compound is blended in an amount of 1 to 12 parts by mass to 100 parts by mass of the base resin, the fatty acid-containing compound is blended in an amount of 1 to 10 parts by mass to 100 parts by mass of the base resin, and the filler is blended in an amount of 10 to 80 parts by mass to 100 parts by mass of the base resin. A content of a low-density polyethylene in the base resin is 10 to 90 mass %, a content of a low-density polyethylene-based thermoplastic elastomer in the base resin is 10 to 90 mass %, and a content of a modified polyethylene in the base resin is 0 to 80 mass %. The filler is composed of calcium carbonate, a silicate compound, or a mixture thereof.

The flame-retardant resin composition of one or more embodiments of the present invention has excellent flame retardancy, easy tearing properties, flexibility and mechanical properties.

Hereinafter, the base resin, the silicone compound, the fatty acid-containing compound and the filler will be described in detail.

(A) Base Resin

The base resin includes the low density polyethylene and the low density polyethylene-based thermoplastic elastomer. The base resin may include the modified polyethylene.

(A1) Low Density Polyethylene

The low density polyethylene means a polyethylene having a density of 930 kg/m³ or less.

The density of the low density polyethylene may be 920 kg/m³ or less. In this case, compared to a case where the density of the low density polyethylene exceeds 920 kg/m³, the flame-retardant resin composition is more excellent in flexibility. However, the density of the low density polyethylene may be 900 kg/m³ or more. In this case, compared to a case where the density of the low density polyethylene is lower than 900 kg/m³, the flame-retardant resin composition is more excellent in blocking resistance.

Examples of the low density polyethylene include linear low density polyethylene (LLDPE) and branched low density polyethylene.

The content of the low density polyethylene in the base resin is 10 to 90 mass %.

In this case, compared to a case where the content of the low-density polyethylene in the base resin is less than 10 mass %, the flame-retardant resin composition has more excellent easy tearing properties. Further, compared to a case where the content of the low-density polyethylene in the base resin exceeds 90 mass %, the flame-retardant resin composition has more excellent in flexibility.

The content of the low density polyethylene in the base resin may be 40 mass % or more. In this case, compared to a case where the content of the low-density polyethylene in the base resin is less than 40 mass %, easy tearing properties of the flame-retardant resin composition can be further improved. The content of the low density polyethylene in the base resin may be 50 mass % or more. However, the content of the low-density polyethylene in the base resin may be 85 mass % or less. In this case, the flexibility of the flame-retardant resin composition can be further improved as compared to a case where the content of the low-density polyethylene in the base resin exceeds 85 mass %. The content of the low density polyethylene in the base resin may be 80 mass % or less.

(A2) Low Density Polyethylene Thermoplastic Elastomer

The Low density polyethylene-based thermoplastic elastomer means a polyethylene-based thermoplastic elastomer having a density of 900 kg/m³ or less.

The density of the low density polyethylene-based thermoplastic elastomer may be 895 kg/m³ or less. In this case, compared to a case where the density of the low density polyethylene-based thermoplastic elastomer exceeds 895 kg/m³, the flame-retardant resin composition is more excellent in flexibility. The density of the low density polyethylene-based thermoplastic elastomer may be 890 kg/m³ or less. However, the density of the low density polyethylene-based thermoplastic elastomer may be 870 kg/m³ or more. In this case, compared to a case where the density of the low density polyethylene-based thermoplastic elastomer is less than 870 kg/m³, the flame-retardant resin composition is more excellent in blocking resistance. The density of the low density polyethylene-based thermoplastic elastomer may be 875 kg/m³ or more.

Examples of the polyethylene-based thermoplastic elastomer include ethylene-α-olefin copolymers. Examples of the α-olefin include butene-1 and propylene.

The content of the low density polyethylene-based thermoplastic elastomer in the base resin is 10 to 90 mass %. In this case, the flame-retardant resin composition has more excellent flexibility as compared to a case where the content of the low-density polyethylene-based thermoplastic elastomer in the base resin is less than 10 mass %. Compared to a case where the content of the low density polyethylene-based thermoplastic elastomer in the base resin exceeds 90 mass %, the flame retardant resin composition has more excellent easy tearing properties.

The content of the low-density polyethylene-based thermoplastic elastomer in the base resin may be 15 mass % or more. In this case, the flexibility of the flame-retardant resin composition can be further improved as compared to a case where the content of the low-density polyethylene-based thermoplastic elastomer in the base resin is less than 15 mass %. The content of the low-density polyethylene-based thermoplastic elastomer in the base resin may be 20 mass % or more. However, the content of the low-density polyethylene-based thermoplastic elastomer in the base resin may be 60 mass % or less. In this case, the blocking resistance of the flame-retardant resin composition can be further improved as compared to a case where the content of the low-density polyethylene-based thermoplastic elastomer in the base resin exceeds 60 mass %. The blocking resistance means that the flame-retardant resin compositions are difficult to fuse when the flame-retardant resin compositions are used in a high-temperature environment. When the blocking resistance is improved, it is more sufficiently suppressed that the amount of the extruded molded body becomes unstable when the flame-retardant resin composition is extruded. The content of the low-density polyethylene-based thermoplastic elastomer in the base resin may be 45 mass % or less.

(A3) Modified Polyethylene

The modified polyethylene may has a density of 895 kg/m³ or less. In this case, compared to a case where the density of the modified polyethylene exceeds 895 kg/m³, the flame-retardant resin composition is more excellent in flexibility.

The density of the modified polyethylene may be 890 kg/m³ or less. In this case, compared to a case where the density of the modified polyethylene exceeds 890 kg/m³, the flame-retardant resin composition is more excellent in flexibility. However, the density of the modified polyethylene is 865 kg/m³ or more. In this case, compared to a case where the density of the modified polyethylene is less than 865 kg/m³, the flame-retardant resin composition is more excellent in blocking resistance. The density of the modified polyethylene may be 870 kg/m³ or more.

“Modified polyethylene” means a polyethylene in which a portion of hydrogen atoms is substituted with other substituents. Examples of the modified polyethylene include an ethylene-vinyl acetate copolymer, an ethylene-acrylic acid ester copolymer, an ethylene-methacrylic acid ester copolymer, a maleic acid-modified polyethylene and a maleic anhydride-modified polyethylene. “Modified polyethylene” may also be referred to as an “acid-modified polyethylene.”

The base resin may or may not contain the modified polyethylene, but the content of the modified polyethylene in the base resin is from 0 to 80 mass %. In this case, the flame-retardant resin composition is more excellent in flame-retardancy as compared to a case where the content of the modified polyethylene in the base resin exceeds 80 mass %.

The content of the modified polyethylene in the base resin may be 5 mass % or more. In this case, the mechanical properties of the flame-retardant resin composition can be further improved. However, the content of the modified polyethylene in the base resin may be 20 mass % or less. In this case, easy tearing properties of the flame-retardant resin composition can be further improved as compared to a case where the content of the modified polyethylene in the base resin exceeds 20 mass %.

(B) Silicone Compound

The silicone compound functions as a flame retardant, and examples of the silicone compound include a polyorganosiloxane. The polyorganosiloxane has a siloxane bond as the main chain and an organic group in the side chain. Examples of the organic group include an alkyl group such as a methyl group, an ethyl group or a propyl group; a vinyl group; and an aryl group such as a phenyl group. Specific examples of the polyorganosiloxane include dimethylpolysiloxane, methyl ethyl polysiloxane, methyloctylpolysiloxane, methylvinylpolysiloxane, methylphenylpolysiloxane and methyl (3,3,3-trifluoropropyl)polysiloxane. The polyorganosiloxane is used in the form of silicone oil, silicone powders, silicone gum or silicone resins. Among these, the polyorganosiloxane may be used in the form of silicone gum. In this case, compared to a case where the silicone compound is a silicone compound other than the silicone gum, bloom is difficult to occur in the flame-retardant resin composition.

The silicone compound is blended in an amount of 1 to 12 parts by mass to 100 parts by mass of the base resin as described above. In this case, the flame retardancy of the flame-retardant resin composition can be improved as compared to a case where the amount of the silicone compound blended to 100 parts by mass of the base resin is less than 1 part by mass.

The mechanical properties of the flame-retardant resin composition can be further improved as compared to a case where the amount of the silicone compound blended to 100 parts by mass of the base resin exceeds 12 parts by mass. The amount of the silicone compound blended to 100 parts by mass of the base resin may be 10 parts by mass or less.

The amount of the silicone compound blended to 100 parts by mass of the base resin may be 3 parts by mass or more. In this case, the flame retardancy of the flame-retardant resin composition can be further improved as compared to a case where the amount of the silicone compound blended to 100 parts by mass of the base resin is less than 3 parts by mass. The amount of the silicone compound blended to 100 parts by mass of the base resin may be 4 parts by mass or more.

(C) Fatty Acid-Containing Compound

The fatty acid-containing compound functions as a flame retardant. The fatty acid-containing compound means a fatty acid or a metal salt thereof. As the fatty acid, a fatty acid having, for example, 12 to 28 carbon atoms is used. Examples of such a fatty acid include lauric acid, myristic acid, palmitic acid, stearic acid, tuberculostearic acid, oleic acid, linoleic acid, arachidonic acid, behenic acid and montanic acid. Among them, stearic acid or tuberculostearic acid is preferable as the fatty acid, and stearic acid is particularly preferable. In this case, more excellent flame retardancy can be obtained as compared to a case where a fatty acid other than stearic acid or tuberculosis stearic acid is used.

The fatty acid-containing compound may be a fatty acid metal salt. In this case, compared to a case where the fatty acid-containing compound is a fatty acid, more excellent flame retardancy can be obtained in the flame-retardant resin composition. Examples of the metal constituting the fatty acid metal salt include magnesium, calcium, zinc and lead. Magnesium stearate is preferable as the fatty acid metal salt. In this case, compared to a case where a fatty acid metal salt other than magnesium stearate is used, more excellent flame retardancy can be obtained with less addition amount in the flame-retardant resin composition.

The fatty acid-containing compound is blended in an amount of 1 to 10 parts by mass to 100 parts by mass of the base resin as described above. In this case, the flame retardancy of the flame-retardant resin composition can be improved as compared to a case where the amount of the fatty acid-containing compound to 100 parts by mass of the base resin is less than 1 part by mass.

Compared to a case where the amount of the fatty acid-containing compound blended to 100 parts by mass of the base resin exceeds 10 parts by mass, the mechanical properties of the flame-retardant resin composition can be further improved. The amount of the fatty acid-containing compound blended to 100 parts by mass of the base resin is 8 parts by mass or less.

The amount of the fatty acid-containing compound blended to 100 parts by mass of the base resin may be 3 parts by mass or more. In this case, the flame retardancy of the flame-retardant resin composition can be further improved as compared to a case where the amount of the fatty acid-containing compound blended to 100 parts by mass of the base resin is less than 3 parts by mass. The amount of the fatty acid-containing compound blended to 100 parts by mass of the base resin may be 4 parts by mass or more.

(D) Filler

The filler is composed of at least one selected from the group consisting of calcium carbonate and a silicate compound.

Calcium carbonate may be either heavy calcium carbonate or light calcium carbonate, but is preferably heavy calcium carbonate since it is readily available and inexpensive. The calcium carbonate mainly acts as a flame retardant, and can realize excellent easy tearing properties easily by blending calcium carbonate since an interference is formed with the base resin and hence the interface becomes a starting point of tearing when the flame-retardant resin composition is used for a cable and the cable is subjected to a tearing process for terminal processing.

Examples of the silicate compound include clay and talc. These can be used alone or in combination of two or more.

The clay may be calcined clay or non-calcined clay, but is preferably calcined clay. Because the calcined clay has less moisture content than the non-calcined clay, moisture in the filler becomes less as compared to a case where the clay is non-calcined clay. Therefore, bubbles can be reduced in the molded body obtained by molding the flame-retardant resin composition, and the appearance of the molded body can be improved.

The filler is blended in an amount of 10 to 80 parts by mass to 100 parts by mass of the base resin. In this case, compared to a case where the amount of the filler blended to 100 parts by mass of the base resin is less than 10 parts by mass, the flame retardancy and easy tearing properties of the flame-retardant resin composition can be further improved. Further, compared to a case where the amount of the filler blended to 100 parts by mass of the base resin exceeds 80 parts by mass, the mechanical properties and flexibility of the flame-retardant resin composition can be further improved.

The amount of the filler blended to 100 parts by mass of the base resin may be 20 parts by mass or more. In this case, the flame retardancy of the flame-retardant resin composition can be further improved as compared to a case where the amount of the filler blended to 100 parts by mass of the base resin is less than 20 parts by mass. The amount of the filler blended to 100 parts by mass of the base resin may be 30 parts by mass or more, and may be 35 parts by mass or more.

The amount of the filler blended to 100 parts by mass of the base resin may be 60 parts by mass or less. In this case, the mechanical properties and flexibility of the flame-retardant resin composition can be further improved as compared to a case where the amount of the filler blended to 100 parts by mass of the base resin exceeds 60 parts by mass. The amount of the filler blended to 100 parts by mass of the base resin may be 50 parts by mass or less.

The flame-retardant resin composition may or may not contain a hindered amine compound, but the flame-retardant resin composition may contain a hindered amine compound.

The hindered amine compound may be a compound having a group represented by the following formula (1):

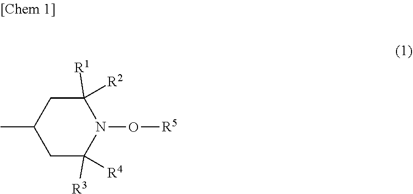

In the above formula (1), R¹ to R⁴ each independently represent an alkyl group having 1 to 8 carbon atoms; R⁵ represents an alkyl group having 1 to 18 carbon atoms, a cycloalkyl group having 5 to 12 carbon atoms, an aralkyl group having 7 to 25 carbon atoms, or an aryl group having 6 to 12 carbon atoms.

In the above formula (1), examples of the alkyl group represented by R¹ to R⁴ include a methyl group, an ethyl group, a propyl group, a butyl group, a pentyl group, a hexyl group, a heptyl group, and an octyl group.

Here, “alkyl group” includes not only a non-substituted alkyl group, but also a substituted alkyl group. As the substituted alkyl group, a substituted alkyl group in which a hydrogen atom of the non-substituted alkyl group is substituted with a halogen atom such as chlorine can be used.

In the above formula (1), examples of the alkyl group represented by R⁵ include a methyl group, an ethyl group, a propyl group, a butyl group, a pentyl group, a hexyl group, a heptyl group, an octyl group, a nonyl group, a decyl group, an undecyl group, a dodecyl group, a tridecyl group, a tetradecyl group, a pentadecyl group, a hexadecyl group, a heptadecyl group and an octadecyl group.

Examples of the cycloalkyl group represented by R⁵ include a cyclopentyl group, a cyclohexyl group, a cycloheptyl group, a cyclooctyl group, a cyclononyl group, a cyclodecyl group, a cycloundecyl group, and a cyclododecyl group.

Examples of the aralkyl group represented by R⁵ include a benzyl group (a phenylmethyl group), a phenylethyl group, a phenylpropyl group, a diphenylmethyl group, and a triphenylmethyl group.

Examples of the aryl group represented by R⁵ include a phenyl group and a naphthyl group.

In the above formula (1), R¹ to R⁴ each independently may represent an alkyl group having 1 to 3 carbon atoms, and R⁵ may represent a cycloalkyl group having 5 to 8 carbon atoms.

In this case, excellent flame retardancy can be obtained in the flame-retardant resin composition.

Examples of the hindered amine compound having a group represented by the above formula (1) include a compound represented by the following formula (2):

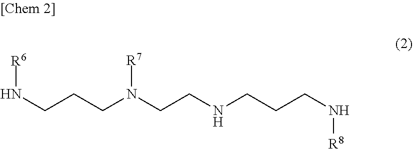

In the above formula (2), R⁶ to R⁸ each independently represent a group represented by the following formula (3):

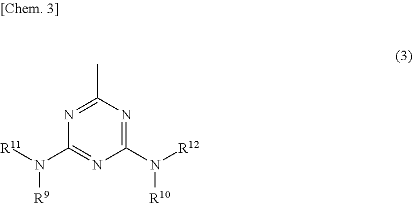

In the above formula (3), R⁹ and R¹⁰ each independently represent a group represented by the above formula (1), R¹¹ and R¹² each independently represent an alkyl group having 1 to 18 carbon atoms.

Examples of the alkyl group represented by R¹¹ and R¹² include the same alkyl group as the alkyl group represented by R⁵ in the above formula (1).

The hindered amine compound may be a compound which is represented by the above formula (2) and in which R¹ to R⁴ in the formula (1) each independently represent an alkyl group having 1 to 3 carbon atoms, R⁵ represents a cycloalkyl group having 5 to 8 carbon atoms, and R¹¹ and R¹² in the formula (3) represent an alkyl group having 1 to 6 carbon atoms. In this case, more excellent flame retardancy can be obtained in the flame-retardant resin composition.

Specific examples of the hindered amine compound include a compound represented by the above formula (2), in which R¹ to R⁴ in the formula (1) are methyl groups, R⁵ is a cyclohexyl group, R¹¹ and R¹² in the formula (3) are represented by butyl groups, R⁶ to R⁸ are identical to each other, and R⁹ and R¹⁰ are identical to each other (trade name “Flamestab NOR 116 FF”, manufactured by BASF).

In a case where the flame-retardant resin composition contains the hindered amine compound, the amount of the hindered amine compound blended to 100 parts by mass of the base resin is not particularly limited, but may be 0.1 to 8 parts by mass.

In this case, the flame retardancy of the flame-retardant resin composition can be further improved as compared to a case where the flame-retardant resin composition further contains the hindered amine compound in an amount of less than 0.1 parts by mass to 100 parts by mass of the base resin. The mechanical properties of the flame-retardant resin composition can be further improved as compared to a case where the flame-retardant resin composition further contains the hindered amine compound in an amount of more than 8 parts by mass to 100 parts by mass of the base resin.

The amount of the hindered amine compound blended to 100 parts by mass of the base resin may be 5 parts by mass or less, and may be 2 parts by mass or less.

The amount of the hindered amine compound blended to 100 parts by mass of the base resin may be 0.2 parts by mass or more, and may be 0.3 parts by mass or more.

The flame-retardant resin composition may further contain a filler such as an antioxidant, an ultraviolet deterioration inhibitor, a processing aid, a coloring pigment or a lubricant as necessary.

The flame-retardant resin composition can be obtained by kneading the base resin, the silicone compound, the fatty acid-containing compound and the fillers. The kneading can be carried out by a kneader such as a Banbury mixer, a tumbler, a pressure kneader, a kneading extruder, a twin screw extruder or a mixing roll. At this time, from the viewpoint of improving the dispersibility of the silicone compound, it may be carried out to knead a portion of the base resin with the silicone compound and then knead the obtained master batch (MB) with the remaining base resin, the fatty acid-containing compound, the fillers, and the like.

<Cable>

(First Embodiment of Cable>

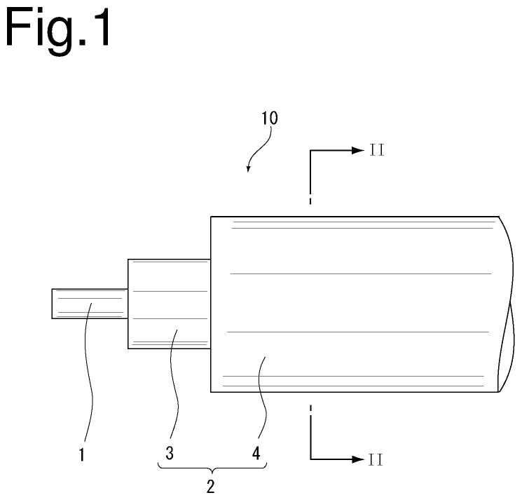

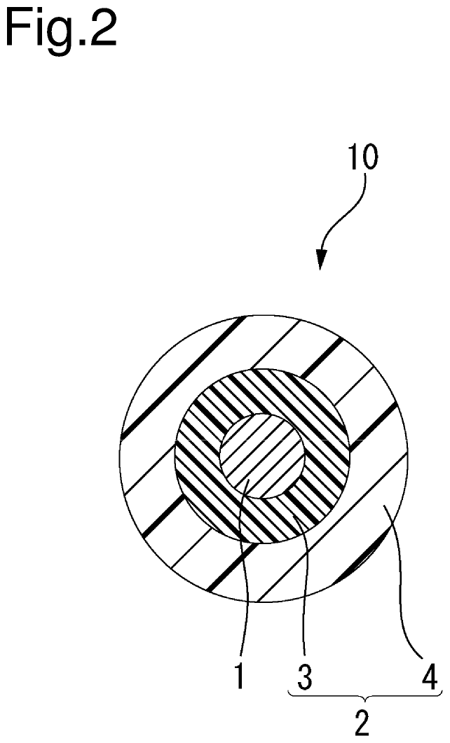

Next, the first embodiment of the cable of the present invention will be described with reference to FIG. 1 and FIG. 2. FIG. 1 is a partial side view showing the first embodiment of a cable according to the present invention, and FIG. 2 is a cross-sectional view taken along line II-II of FIG. 1.

As shown in FIGS. 1 and 2, a cable 10 includes a conductor 1 as a transmission medium and an insulator 2 covering the conductor 1. The insulator 2 has a first insulating layer 3 as an insulating part covering the conductor 1, and a second insulating layer 4 as an insulating part covering the first insulating layer 3.

Here, the first insulating layer 3 and the second insulating layer 4 are composed of the flame-retardant resin composition described above, and the flame-retardant resin composition described above has excellent flame retardancy, easy tearing properties, flexibility and mechanical properties. For this reason, the cable 10 has excellent flame retardancy, flexibility and mechanical properties, and allows stripping of the cable to be easily performed.

(Conductor)

The conductor 1 may be composed of only one strand, and may be constituted by bundling a plurality of strands. The conductor 1 is not particularly limited in terms of the diameter of the conductor and the material of the conductor, and can be appropriately determined depending on the application. As the material of the conductor 1, for example, copper, aluminum, or an alloy containing them may be used, or a conductive substance such as a carbon material can also be suitably used.

(Second Embodiment of Cable)

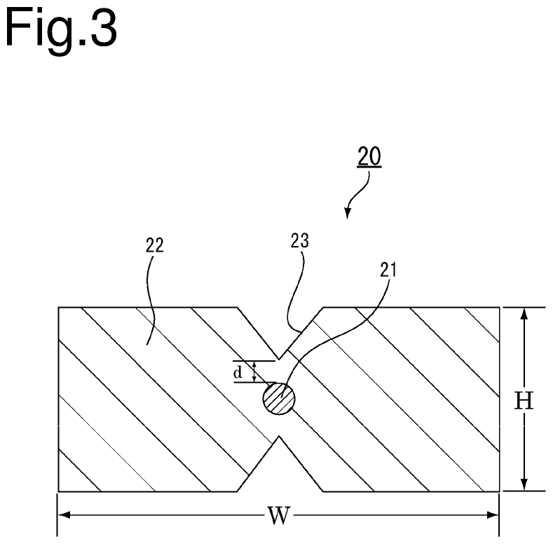

Next, the second embodiment of the cable of the present invention will be described with reference to FIG. 3. FIG. 3 is a cross-sectional view of an optical fiber cable as the second embodiment of the cable of the present invention.

As shown in FIG. 3, a cable 20 includes an optical fiber 21 as a transmission medium and an insulator 22 covering the optical fiber. Here, the optical fiber 21 is provided so as to penetrate the insulator 22. Here, the insulator 22 is composed of an insulating part, and the insulating part is composed of the flame-retardant resin composition constituting the first insulating layer 3 and the second insulating layer 4 in the first embodiment of the cable. The insulator 22 include notches 3 formed so as to sandwich the optical fiber 21.

Here, the flame-retardant resin composition described above has excellent flame retardancy, easy tearing properties, flexibility and mechanical properties. The insulating part is composed of the flame-retardant resin composition. Therefore, the cable 20 has excellent flame retardancy, flexibility and mechanical properties, and allows tearing of the cable to be easily performed.

The present invention is not limited to the above embodiments. For example, in the above embodiment, the cable 10 has only one conductor 1. However, the cable of the present invention is not limited to a cable having only one conductor 1, and may be a cable having a plurality of conductors 1 spaced apart from each other.

In the above-described embodiment, the cable 10 has the insulator 2 composed of the first insulating layer 3 and the second insulating layer 4 as insulating parts. However, in the insulator 2, the number of the insulating part is not limited to two, and may be one or plural. Accordingly, in the insulator 2, either the first insulating layer 3 or the second insulating layer 4 may be omitted, or an insulating layer as an insulating part may be further added as necessary.

Further, in the cable 20, the insulator 22 is composed of an insulating part, but, the insulator 22 may further comprise a covering part covering the insulating part and not composed of the flame-retardant resin composition constituting the first insulating layer 3 and the second insulating layer 4 in the above embodiment. The cable 20 may not necessarily have the notches 23.

### EXAMPLES

Hereinafter, the contents of the present invention will be more specifically described with reference to Examples and Comparative Examples, but the present invention is not limited to the following Examples.

### Examples 1 to 34 and Comparative Examples 1 to 12

A base resin, a silicone master batch (silicone MB), a fatty acid-containing compound, a filler and a hindered amine compound were blended in a blended amount shown in Tables 1 to 6 and kneaded at 170° C. for 10 minutes with a Banbury mixer to obtain a flame-retardant resin composition. Here, the silicone MB is a mixture of a low density polyethylene and silicone gum. In Tables 1 to 6, the unit of the blended amount of each component blended is part(s) by mass. In Tables 1 to 6, in many cases, the total blended amount in the column of the “base resin” are not 100 parts by mass. However, the base resin is composed of a mixture of the base resin in the column of the “base resin” and the low density polyethylene in the silicone MB, and when the total blended amount of the base resins in the column of the “base resin” and the blended amount of the low density polyethylene in the silicone MB are summed, the total is 100 parts by mass.

As the base resin, the silicone MB, the fatty acid-containing compound, the filler and the hindered amine compound, the followings were specifically used.

Base Resin

### (1) Polyethylene

### (1-1) High Density Polyethylene (HDPE)

Product name “Novatec HD322W”, manufactured by Japan Polyethylene Corporation, Density: 951 kg/m³

### (1-2) Linear Low Density Polyethylene 1 (LLDPE 1)

Product name “Excellen GH030”, manufactured by Sumitomo Chemical Company, Limited, Density: 912 kg/m³

### (1-3) Linear Low Density Polyethylene 2 (LLDPE 2)

Product name “Excellen CB2001”, manufactured by Sumitomo Chemical Company, Limited, Density: 920 kg/m³

### (1-4) Low Density Polyethylene (LDPE)

Product name “UBEC 150”, manufactured by Ube-Maruzen Polyethlene Co, Ltd., Density: 919 kg/m³

### (2) Modified Polyethylene (Modified PE (Acid-Modified PE))

Product name “Tafmer MA8510”, manufactured by Mitsui Chemicals, Inc., Density: 885 kg/m³

### (3) Low Density Polyethylene-Based Thermoplastic Elastomer (Low Density PE Elastomer)

Product name “Tafmer DF840”, manufactured by Mitsui Chemicals, Inc., Density: 885 kg/m³

Silicone MB (Polyethylene/Silicone Compound)

Product name “X-22-2125 H”, manufactured by Shin-Etsu Chemical Co., Ltd. (containing 50 mass % of low density polyethylene (density 915 kg/m³) and 50 mass % of silicone gum (dimethylpolysiloxane))

Fatty Acid-containing Compound

### (1) Magnesium Stearate (StMg)

Product name “Afco-Chem MGS”, manufactured by ADEKA Corporation

### (2) Zinc Stearate (StZn)

Product name “Zinc stearate GF-200”, manufactured by NOF Corporation

### (3) Stearic Acid

Product name “Stearic acid Sakura”, manufactured by NOF Corporation

Filler

### (1) Calcium Carbonate

Product name “NCC P”, manufactured by Nitto Funka Kogyo K.K.

### (2) Calcined Clay

Product name “ICECAP-K”, manufactured by Burgess Pigment

Hindered Amine Compound

Product name “Flamestab NOR116FF”, manufactured by BASF (NOR type hindered amine compound)

[Characteristics Evaluation]

For the flame-retardant resin compositions of Examples 1 to 34 and Comparative Examples 1 to 12 obtained as described above, flame retardancy, easy tearing properties, flexibility, mechanical properties and blocking resistance were evaluated.

Evaluation of flame retardancy and easy tearing properties was performed using metal cables and optical fiber cables prepared as described later using the flame-retardant resin compositions of Examples 1 to 34 and Comparative Examples 1 to 12.

The flexibility was evaluated using a sheet-like molded body prepared as described later using the flame-retardant resin compositions of Examples 1 to 34 and Comparative Examples 1 to 12.

(Fabrication of Metal Cable)

The flame-retardant resin composition of Examples 1 to and Comparative Examples 1 to 12 was charged into a single-screw extruder (L/D=20, screw shape: full flight screw, manufactured by Marth Seiki Co., Ltd) and kneaded. Then, a tubular extrudate was extruded from the extruder and was coated on a conductor having a cross-sectional area of 2 mm² to have a thickness of 0.7 mm. Thus, a metal cable was prepared.

(Fabrication of Optical Fiber Cable)

The flame-retardant resin composition of Examples 1 to 34 and Comparative Examples 1 to 12 was charged into a single-screw extruder (L/D=20, screw shape: full flight screw, manufactured by Marth Seiki Co., Ltd) and kneaded. Then, a tubular extrudate was extruded as an insulator from the extruder and was coated on a coated optical fiber to obtain an optical fiber cable. In addition, the cross-sectional face of the optical fiber cable was a shape as illustrated in FIG. 3, that is, a rectangular shape where height H was 1.6 mm, width W was 2.0 mm, tearing notches were formed along the height direction and the distance d between the bottom part of the tearing notch and the coated optical fiber was 4.0 mm.

(Fabrication of Sheet-Like Molded Body)

The flame-retardant resin composition of Examples 1 to 34 and Comparative Examples 1 to 12 was molded using a mold to obtain a sheet-like molded body having a dimension of 1 mm in thickness X 50 mm×10 mm.

<Flame-Retardancy>

(1) Flame Retardancy Based on Horizontal Combustion Test

For five metal cables obtained as described above, horizontal combustion tests were conducted in accordance with JASO D618. Flame contact was performed for 5 seconds. The ratio (unit: %) of the number of metal cables self-extinguishing within 30 seconds without dripping during combustion to the number of metal cables subjected to the horizontal combustion tests was calculated as self-extinguishing ratio 1 on the basis of the following formula. The results are shown in Tables 1 to 6.

Self-extinguishing ratio 1(%)=100×the number of self-extinguishing metal cable(s)/the total number(five) of metal cables subjected to the horizontal combustion tests

### (2) Flame Retardancy Based on Vertical Combustion Test

For five metal cables obtained as described above, vertical combustion tests for a single cable were conducted in accordance with IEC 60332-1. Flame contact was performed for seconds. The ratio (unit:%) of the number of self-extinguishing metal cables within 60 seconds without dripping during combustion to the number of cables subjected to the vertical combustion tests was calculated as self-extinguishing ratio 2 on the basis of the following formula. The results are shown in Tables 1 to 6.

Self-extinguishing ratio 2(%)=100×the number of self-extinguishing metal cables/the total number (five) of metal cables subjected to the vertical combustion tests

### (3) Acceptance Criteria

The acceptance criteria for flame retardancy was as follows:

(Acceptance Criteria) Self-extinguishing ratio 1 is 100%

<Easy Tearing Properties>

Five optical fiber cables obtained as described above were used, and each of their insulators was teared over a length of 5 cm from its tip along the notch in advance, and both ends of the teared insulator were fixed to chucks, and the insulator was teared over a length of 200 mm at a tensile speed of 500 mm/min, and a tearing force (notch tearing force) at this time was measured. As the tearing force, a value obtained by averaging the measurement results obtained for the five optical fiber cables was adopted. The acceptance criteria for easy tear properties were as follows:

(Acceptance Criteria) The tearing force is 25 N or less

<Flexibility>

For the sheet-like molded bodies obtained as described above, bending stress was measured. Specifically, a sheet was placed on a jig having an inter-fulcrum distance of 16 mm and then, a load where the deflection of the sheet was 4 mm in applying a load was obtained. This load was used as a bending stress. The results are shown in Tables 1 to 6. The acceptance criteria for flexibility were as follows:

(Acceptance Criteria) Bending stress is 10 N or less

<Mechanical Properties>

The flame-retardant resin compositions of Examples 1 to 34 and Comparative Examples 1 to 12 were used to mold the JIS No. 3 Dumbbell test pieces, and the test pieces were used to perform tensile tests in accordance with JIS C3005 to measure breaking strengths and elongations. The results are shown in Tables 1 to 6. In addition, the tensile tests were carried out under the conditions of a tensile speed of 200 mm/min and a distance between the target lines of 20 mm. The values of breaking strengths and elongations shown in Tables 1 to 6 were the average values of the measured values of the breaking strengths and elongations of the five test pieces prepared for each of Examples 1 to 34 and Comparative Examples 1 to 12. The acceptable criteria for mechanical properties were as follows:

(Acceptance Criteria) Breaking strength is 10 MPa or more and elongation is 350% or more.

<Blocking Resistance>

100 g of pellets having a size of 2.5 mm×3.5 mm made using the flame-retardant resin compositions of Examples 1 to 34 and Comparative Examples 1 to 12 was placed in a cylindrical container having a circular bottom surface and a volume of 50 cm³ and was allowed to stand at 50° C. for 72 hours with a load of 4 kg applied. The presence or absence of fusion in the pellets was visually confirmed. The results are shown in Tables 1 to 6. In Tables 1 to 6, pellets in which fusion was not observed were expressed as “◯”, and pellets in which fusion was observed were expressed as “x.”

TABLE 1

| | | | | Comparative | Comparative | | |
|---|---|---|---|---|---|---|---|
| | | | | Example 1 | Example 2 | Example 1 | Example 2 |
| Compostion | Base Resin | Polyethylene | HDPE (Density: 951 kg/m³) | 66 | | | |
| | | | LLDPE1 (Density: 912 kg/m³) | | | | |
| | | | LLDPE2 (Density: 920 kg/m³) | | 96 | 81 | 66 |
| | | | LDPE (Density: 919 kg/m³) | | | | |
| | | Acid-modified Low Density PE (Density: 885 kg/m³) | | | | | |
| | | Low Density PE Elastomer (Density: 885 kg/m³) | | 30 | | 15 | 30 |
| | Silicone MB | Polyethylene | Density: 915 kg/m³) | 4 | 4 | 4 | 4 |
| | | Silicone Compound | Silicone Gum | 4 | 4 | 4 | 4 |
| | Fatty Acid-containing Compound | | StMg | 5 | 5 | 5 | 5 |
| | Hindered Amine Compound | | NOR Type | 0.3 | 0.3 | 0.3 | 0.3 |
| | Filler | | Calcium Carbonate | 40 | 40 | 40 | 40 |
| Characteristics | Flame Retardancy | Vertical Combustion Test | Self-extinguishing Ratio 2 (%) | 100 | 100 | 100 | 100 |
| Evaluation | | Horizontal Combustion Test | Self-extinguishing Ratio 1 (%) | 100 | 100 | 100 | 100 |
| | Easy Tearing Properties | | Notch Tearing Force (N) | 38.0 | 11.7 | 14.1 | 16.6 |
| | Flexibility | | Bending Stress (N) | 15.7 | 14.7 | 9.8 | 8.8 |
| | Mechanical Properties | | Breaking Strength (MPa) | 16.0 | 12.4 | 13.1 | 13.9 |
| | | | Tensile Elongation (%) | 750 | 630 | 660 | 700 |
| | Blocking Resistance | | | ○ | ○ | ○ | ○ |
| | | | | | Comparative | Comparative | |
| | | | | Example 3 | Example 3 | Example 4 | Example 4 |
| Compostion | Base Resin | Polyethylene | HDPE (Density: 951 kg/m³) | | | | |
| | | | LLDPE1 (Density: 912 kg/m³) | 66 | | | |
| | | | LLDPE2 (Density: 920 kg/m³) | | | | |
| | | | LDPE (Density: 919 kg/m³) | | 96 | 91 | 86 |
| | | Acid-modified Low Density PE (Density: 885 kg/m³) | | | | | |
| | | Low Density PE Elastomer (Density: 885 kg/m³) | | 30 | | 5 | 10 |
| | Silicone MB | Polyethylene | Density: 915 kg/m³) | 4 | 4 | 4 | 4 |
| | | Silicone Compound | Silicone Gum | 4 | 4 | 4 | 4 |
| | Fatty Acid-containing Compound | | StMg | 5 | 5 | 5 | 5 |
| | Hindered Amine Compound | | NOR Type | 0.3 | 0.3 | 0.3 | 0.3 |
| | Filler | | Calcium Carbonate | 40 | 40 | 40 | 40 |
| Characteristics | Flame Retardancy | Vertical Combustion Test | Self-extinguishing Ratio 2 (%) | 100 | 100 | 100 | 100 |
| Evaluation | | Horizontal Combustion Test | Self-extinguishing Ratio 1 (%) | 100 | 100 | 100 | 100 |

| | | | | | |
|---|---|---|---|---|---|
| Easy Tearing Properties | Notch Tearing Force (N) | 16.8 | 11.4 | 12.2 | 13.0 |
| Flexibility | Bending Stress (N) | 9.6 | 11.1 | 10.6 | 9.9 |
| Mechanical Properties | Breaking Strength (MPa) | 15.8 | 9.8 | 10.3 | 10.6 |
| | Tensile Elongation (%) | 750 | 420 | 480 | 490 |

| | | | | |
|---|---|---|---|---|
| Blocking Resistance | ○ | ○ | ○ | ○ |

TABLE 2

| | | | | Example | Example | Example | Example | Example |
|---|---|---|---|---|---|---|---|---|
| | | | | 5 | 6 | 7 | 8 | 9 |
| Compostion | Base Resin | Polyethylene | HDPE (Density: 951 kg/m³) | | | | | |
| | | | LLDPE1 (Density: 912 kg/m³) | | | | | |
| | | | LLDPE2 (Density: 920 kg/m³) | | | | | |
| | | | LDPE (Density: 919 kg/m³) | 81 | 66 | 56 | 36 | 31 |
| | | Acid-modified Low Density PE (Density: 885 kg/m³) | | | | 10 | | |
| | | Low Density PE Elastomer (Density: 885 kg/m³) | | 15 | 30 | 30 | 60 | 65 |
| | Silicone | Polyethylene | Density: 915 kg/m³) | 4 | 4 | 4 | 4 | 4 |
| | MB | Silicone Compound | Silicone Gum | 4 | 4 | 4 | 4 | 4 |
| | Fatty Acid-containing Compound | | StMg | 5 | 5 | 5 | 5 | 5 |
| | Hindered Amine Compound | | NOR Type | 0.3 | 0.3 | 0.3 | 0.3 | 0.3 |
| | Filler | | Calcium Carbonate | 40 | 40 | 40 | 40 | 40 |
| Characteristics | Flame | Vertical Combustion Test | Self-extinguishing Ratio 2 (%) | 100 | 100 | 100 | 100 | 100 |
| Evaluation | Retardancy | Horizontal Combustion Test | Self-extinguishing Ratio 1 (%) | 100 | 100 | 100 | 100 | 100 |
| | Easy Tearing Properties | | Notch Tearing Force (N) | 13.6 | 15.8 | 16.0 | 19.8 | 20.5 |
| | Flexibility | | Bending Stress (N) | 9.4 | 8.1 | 7.7 | 6.0 | 5.7 |
| | Mechanical Properties | | Breaking Strength (MPa) | 10.9 | 12.0 | 15.8 | 12.2 | 12.3 |
| | | | Tensile Elongation (%) | 510 | 610 | 640 | 680 | 700 |
| | Blocking Resistance | | | ○ | ○ | ○ | ○ | × |
| | | | | | | Com- | Com- | |
| | | | | | | parative | parative | |
| | | | | | Example | Example | Example | Example |
| | | | | | 10 | 11 | 5 | 6 |

| Compostion | Base Resin | Polyethylene | HDPE (Density: 951 kg/m³) | | | | |
|---|---|---|---|---|---|---|---|
| | | | LLDPE1 (Density: 912 kg/m³) | | | | |
| | | | LLDPE2 (Density: 920 kg/m³) | | | | |
| | | | LDPE (Density: 919 kg/m³) | 10 | 6 | 5 | |
| | | Acid-modified Low Density PE (Density: 885 kg/m³) | | | | | |
| | | Low Density PE Elastomer (Density: 885 kg/m³) | | 86 | 90 | 91 | 96 |
| | Silicone | Polyethylene | Density: 915 kg/m³) | 4 | 4 | 4 | 4 |
| | MB | Silicone Compound | Silicone Gum | 4 | 4 | 4 | 4 |
| | Fatty Acid-containing Compound | | StMg | 5 | 5 | 5 | 5 |
| | Hindered Amine Compound | | NOR Type | 0.3 | 0.3 | 0.3 | 0.3 |
| | Filler | | Calcium Carbonate | 40 | 40 | 40 | 40 |
| Characteristics | Flame | Vertical Combustion Test | Self-extinguishing Ratio 2 (%) | 100 | 100 | 100 | 100 |
| Evaluation | Retardancy | Horizontal Combustion Test | Self-extinguishing Ratio 1 (%) | 100 | 100 | 100 | 100 |

| | | | | | |
|---|---|---|---|---|---|
| Easy Tearing Properties | Notch Tearing Force (N) | 24.2 | 24.9 | 25.1 | 26.1 |
| Flexibility | Bending Stress (N) | 5.0 | 5.0 | 4.7 | 4.4 |
| Mechanical Properties | Breaking Strength (MPa) | 12.7 | 12.7 | 12.9 | 13.0 |
| | Tensile Elongation (%) | 720 | 720 | 720 | 740 |

| | | | | |
|---|---|---|---|---|
| Blocking Resistance | × | × | × | × |

TABLE 3

| | | | | Comparative | Example | Example | Example |
|---|---|---|---|---|---|---|---|
| | | | | Example 7 | 12 | 13 | 14 |
| Composition | Base Resin | Polyethylene | LDPE (Density: 919 kg/m3) | 70 | 69 | 68 | 67 |
| | | Low Density PE Elastomer (Density: 885 kg/m3) | | 30 | 30 | 30 | 30 |
| | Silicone | Polyethylene | (Density: 915 kg/m3) | 0 | 1 | 2 | 3 |
| | MB | Silicone compound | Silicone Gum | 0 | 1 | 2 | 3 |
| | Fatty Acid-containing Compound | | StMg | 5 | 5 | 5 | 5 |
| | Hindered Amine Compound | | NOR Type | 0.3 | 0.3 | 0.3 | 0.3 |
| | Filler | | Calcium Carbonate | 40 | 40 | 40 | 40 |
| Characteristics | Flame | Vertical Combustion Test | Self-extinguishing Ratio 2 (%) | 0 | 0 | 60 | 100 |
| Evaluation | Retardancy | Horizontal Combustion Test | Self-extinguishing Ratio 1 (%) | 0 | 100 | 100 | 100 |
| | Easy Tearing Properties | | Notch Tearing Force (N) | 17.3 | 16.7 | 16.4 | 16.1 |
| | Flexibility | | Bending Stress (N) | 8.5 | 8.4 | 8.3 | 8.2 |
| | Mechanical Properties | | Breaking Strength (MPa) | 12.3 | 12.2 | 12.2 | 12.1 |
| | | | Tensile Elongation (%) | 580 | 580 | 600 | 610 |
| | Blocking Resistance | | | ○ | ○ | ○ | ○ |
| | | | | Example | Example | Example | Comparateve |
| | | | | 6 | 15 | 16 | Example 8 |
| Composition | Base Resin | Polyethylene | LDPE (Density: 919 kg/m3) | 66 | 60 | 58 | 55 |
| | | Low Density PE Elastomer (Density: 885 kg/m3) | | 30 | 30 | 30 | 30 |
| | Silicone | Polyethylene | (Density: 915 kg/m3) | 4 | 10 | 12 | 15 |
| | MB | Silicone compound | Silicone Gum | 4 | 10 | 12 | 15 |
| | Fatty Acid-containing Compound | | StMg | 5 | 5 | 5 | 5 |
| | Hindered Amine Compound | | NOR Type | 0.3 | 0.3 | 0.3 | 0.3 |
| | Filler | | Calcium Carbonate | 40 | 40 | 40 | 40 |
| Characteristics | Flame | Vertical Combustion Test | Self-extinguishing Ratio 2 (%) | 100 | 100 | 100 | 100 |
| Evaluation | Retardancy | Horizontal Combustion Test | Self-extinguishing Ratio 1 (%) | 100 | 100 | 100 | 100 |

| | | | | | |
|---|---|---|---|---|---|
| Easy Tearing Properties | Notch Tearing Force (N) | 15.8 | 12.8 | 12.0 | 9.9 |
| Flexibility | Bending Stress (N) | 8.1 | 7.8 | 7.7 | 7.6 |
| Mechanical Properties | Breaking Strength (MPa) | 12.0 | 10.8 | 10.2 | 9.4 |
| | Tensile Elongation (%) | 610 | 630 | 640 | 650 |

| | | | | |
|---|---|---|---|---|
| Blocking Resistance | ○ | ○ | ○ | ○ |

TABLE 4

| | | | | Com- | | | | |
|---|---|---|---|---|---|---|---|---|
| | | | | parative | | | | |
| | | | | Example | Example | Example | Example | Example |
| | | | | 9 | 17 | 18 | 19 | 20 |
| Composition | Base | Polyethylene | LDPE (Density: 919 kg/m³) | 66 | 66 | 66 | 66 | 66 |
| | Resin | Low Density PE Elastomer (Density: 885 kg/m³) | | 30 | 30 | 30 | 30 | 30 |
| | Silicone | Polyethylene | (Density: 915 kg/m³) | 4 | 4 | 4 | 4 | 4 |
| | MB | Silicone compound | Silicone Gum | 4 | 4 | 4 | 4 | 4 |
| | Fatty Acid-containing Compound | | StMg | 0 | 1 | 2 | 3 | 4 |
| | | | StZn | | | | | |
| | | | Stearic acid | | | | | |
| | Hindered Amine Compound | | NOR Type | 0.3 | 0.3 | 0.3 | 0.3 | 0.3 |
| | Filler | | Calcium Carbonate | 40 | 40 | 40 | 40 | 40 |
| Characteristics | Flame | Vertical Combustion Test | Self-extinguishing Ratio 2 (%) | 0 | 0 | 20 | 100 | 100 |
| Evaluation | Retardancy | Horizontal Combustion Test | Self-extinguishing Ratio 1 (%) | 0 | 100 | 100 | 100 | 100 |
| | Easy Tearing Properties | | Notch Tearing Force (N) | 16.4 | 16.2 | 16.1 | 16.1 | 16.0 |
| | Flexibility | | Bending Stress (N) | 8.3 | 8.2 | 8.1 | 8.2 | 8.1 |
| | Mechanical Properties | | Breaking Strength (MPa) | 13.1 | 12.9 | 12.8 | 12.6 | 12.4 |
| | | | Tensile Elongation (%) | 680 | 660 | 640 | 640 | 630 |
| | Blocking Resistance | | | ○ | ○ | ○ | ○ | ○ |
| | | | | | | | | Com- |
| | | | | | | | | parative |
| | | | | Example | Example | Example | Example | Example |
| | | | | 21 | 22 | 6 | 23 | 10 |
| Composition | Base | Polyethylene | LDPE (Density: 919 kg/m³) | 66 | 66 | 66 | 66 | 66 |
| | Resin | Low Density PE Elastomer (Density: 885 kg/m³) | | 30 | 30 | 30 | 30 | 30 |
| | Silicone | Polyethylene | (Density: 915 kg/m³) | 4 | 4 | 4 | 4 | 4 |
| | MB | Silicone compound | Silicone Gum | 4 | 4 | 4 | 4 | 4 |
| | Fatty Acid-containing Compound | | StMg | | | 5 | 10 | 15 |
| | | | StZn | 4 | | | | |
| | | | Stearic acid | | 4 | | | |
| | Hindered Amine Compound | | NOR Type | 0.3 | 0.3 | 0.3 | 0.3 | 0.3 |
| | Filler | | Calcium Carbonate | 40 | 40 | 40 | 40 | 40 |
| Characteristics | Flame | Vertical Combustion Test | Self-extinguishing Ratio 2 (%) | 100 | 100 | 100 | 100 | 100 |
| Evaluation | Retardancy | Horizontal Combustion Test | Self-extinguishing Ratio 1 (%) | 100 | 100 | 100 | 100 | 100 |

| | | | | | | |
|---|---|---|---|---|---|---|
| Easy Tearing Properties | Notch Tearing Force (N) | 15.9 | 15.9 | 15.8 | 15.5 | 15.4 |
| Flexibility | Bending Stress (N) | 8.2 | 8.1 | 8.1 | 8.3 | 8.6 |
| Mechanical Properties | Breaking Strength (MPa) | 12.3 | 12.2 | 12.0 | 10.4 | 9.3 |
| | Tensile Elongation (%) | 640 | 640 | 610 | 660 | 630 |

| | | | | | |
|---|---|---|---|---|---|
| Blocking Resistance | ○ | ○ | ○ | ○ | ○ |

TABLE 5

| | | | | Comparative | Example | Example | Example |
|---|---|---|---|---|---|---|---|
| | | | | Example 11 | 24 | 25 | 6 |
| Composition | Base Resin | Polyethylene | LDPE (Density: 919 kg/m³) | 66 | 66 | 66 | 66 |
| | | Low Density PE Elastomer (Density: 885 kg/m³) | | 30 | 30 | 30 | 30 |
| | Silicone | Polyehtylene | (Density: 915 kg/m³) | 4 | 4 | 4 | 4 |
| | MB | Silicone compound | Silicone Gum | 4 | 4 | 4 | 4 |
| | Fatty Acid-containing Compound | | StMg | 5 | 5 | 5 | 5 |
| | Hindered Amine Compound | | NOR Type | 0.3 | 0.3 | 0.3 | 0.3 |
| | Filler | | Calcium Carbonate | 0 | 10 | 20 | 90 |
| | | | Calcined Clay | | | | |
| Characteristics | Flame | Vertical Combustion Test | Self-extinguishing Ratio 2 (%) | 0 | 100 | 100 | 100 |
| Evaluation | Retardancy | Horizontal Combustion Test | Self-extinguishing Ratio 1 (%) | 0 | 100 | 100 | 100 |
| | Easy Tearing Properties | | Notch Tearing Force (N) | 29.2 | 24.8 | 22.0 | 15.8 |
| | Flexibility | | Bending Stress (N) | 7.3 | 7.5 | 7.7 | 8.1 |
| | Mechanical Properties | | Breaking Strength (MPa) | 16.8 | 15.1 | 14.0 | 12.0 |
| | | | Tensile Elongation (%) | 700 | 680 | 650 | 610 |
| | Blocking Resistance | | | ○ | ○ | ○ | ○ |
| | | | | Example | Example | Example | Comparative |
| | | | | 26 | 27 | 28 | Example 12 |
| Composition | Base Resin | Polyethylene | LDPE (Density: 919 kg/m³) | 66 | 66 | 66 | 66 |
| | | Low Density PE Elastomer (Density: 885 kg/m³) | | 30 | 30 | 30 | 30 |
| | Silicone | Polyehtylene | (Density: 915 kg/m³) | 4 | 4 | 4 | 4 |
| | MB | Silicone compound | Silicone Gum | 4 | 4 | 4 | 4 |
| | Fatty Acid-containing Compound | | StMg | 5 | 5 | 5 | 5 |
| | Hindered Amine Compound | | NOR Type | 0.3 | 0.3 | 0.3 | 0.3 |
| | Filler | | Calcium Carbonate | 60 | | 80 | 100 |
| | | | Calcined Clay | | 60 | | |
| Characteristics | Flame | Vertical Combustion Test | Self-extinguishing Ratio 2 (%) | 100 | 100 | 100 | 100 |
| Evaluation | Retardancy | Horizontal Combustion Test | Self-extinguishing Ratio 1 (%) | 100 | 100 | 100 | 100 |

| | | | | | |
|---|---|---|---|---|---|
| Easy Tearing Properties | Notch Tearing Force (N) | 13.0 | 12.2 | 11.2 | 10.1 |
| Flexibility | Bending Stress (N) | 8.9 | 9.1 | 9.9 | 10.1 |
| Mechanical Properties | Breaking Strength (MPa) | 11.0 | 11.3 | 10.1 | 9.9 |
| | Tensile Elongation (%) | 590 | 540 | 540 | 520 |

| | | | | |
|---|---|---|---|---|
| Blocking Resistance | ○ | ○ | ○ | ○ |

TABLE 6

| | | | | Example | Example | Example | Example |
|---|---|---|---|---|---|---|---|
| | | | | 29 | 30 | 6 | 31 |
| Composition | Base Resin | Polyethylene | LDPE (Density: 919 kg/m³) | 66 | 66 | 66 | 66 |
| | | Low Density PE Elastomer (Density: 885 kg/m³) | | 30 | 30 | 30 | 30 |
| | Silicone | Polyehtylene | (Density: 915 kg/m³) | 4 | 4 | 4 | 4 |
| | MB | Silicone compound | Silicone Gum | 4 | 4 | 4 | 4 |
| | Fatty Acid-containing Compound | | StMg | 5 | 5 | 5 | 5 |
| | Hindered Amine Compound | | NOR Type | 0 | 0.1 | 0.3 | 0.8 |
| | Filler | | Calcium Carbonate | 40 | 40 | 40 | 40 |
| Characteristics | Flame | Vertical Combustion Test | Self-extinguishing Ratio 2 (%) | 60 | 100 | 100 | 100 |
| Evaluation | Retardancy | Horizontal Combustion Test | Self-extinguishing Ratio 1 (%) | 100 | 100 | 100 | 100 |
| | Easy Tearing Properties | | Notch Tearing Force (N) | 15.8 | 15.8 | 15.8 | 15.7 |
| | Flexibility | | Bending Stress (N) | 8.1 | 8.1 | 8.1 | 8.1 |
| | Mechanical Properties | | Breaking Strength (MPa) | 12.3 | 12.2 | 12.0 | 12.0 |
| | | | Tensile Elongation (%) | 620 | 610 | 610 | 610 |
| | Blocking Resistance | | | ○ | ○ | ○ | ○ |
| | | | | | Example | Example | Example |
| | | | | | 32 | 33 | 34 |

| Composition | Base Resin | Polyethylene | LDPE (Density: 919 kg/m³) | 66 | 66 | 66 |
|---|---|---|---|---|---|---|
| | | Low Density PE Elastomer (Density: 885 kg/m³) | | 30 | 30 | 30 |
| | Silicone | Polyehtylene | (Density: 915 kg/m³) | 4 | 4 | 4 |
| | MB | Silicone compound | Silicone Gum | 4 | 4 | 4 |
| | Fatty Acid-containing Compound | | StMg | 5 | 5 | 5 |
| | Hindered Amine Compound | | NOR Type | 2.0 | 5.0 | 8.0 |
| | Filler | | Calcium Carbonate | 40 | 40 | 40 |
| Characteristics | Flame | Vertical Combustion Test | Self-extinguishing Ratio 2 (%) | 100 | 100 | 100 |
| Evaluation | Retardancy | Horizontal Combustion Test | Self-extinguishing Ratio 1 (%) | 100 | 100 | 100 |

| | | | | |
|---|---|---|---|---|
| Easy Tearing Properties | Notch Tearing Force (N) | 15.6 | 15.6 | 15.3 |
| Flexibility | Bending Stress (N) | 8.0 | 8.0 | 7.8 |
| Mechanical Properties | Breaking Strength (MPa) | 11.8 | 10.8 | 10.1 |
| | Tensile Elongation (%) | 600 | 590 | 560 |

| | | | |
|---|---|---|---|
| Blocking Resistance | ○ | ○ | ○ |

From the results shown in Tables 1 to 6, the flame-retardant resin compositions of Examples 1 to 34 reached pass criteria in terms of flame retardancy, easy tearing properties, flexibility and mechanical properties. In contrast, the flame-retardant resin compositions of Comparative Examples 1 to 12 did not reach pass criteria in at least one of flame retardancy, easy tearing properties, flexibility, and mechanical properties.

From this, it has been confirmed that the flame-retardant resin composition of one or more embodiments of the present invention has excellent flame retardancy, easy tearing properties, flexibility and mechanical properties.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1 . . . Conductor (Transmission medium)
2, 22 . . . Insulator
3 . . . First insulating layer (Insulating Part)
4 . . . Second insulating layer (Insulating Part)
10, 20 . . . Cable
21 . . . Optical Fiber (Transmission medium)

1. A flame-retardant resin composition comprising:
a base resin;
a silicone compound in an amount of 1 to 12 parts by mass to 100 parts by mass of the base resin;
a fatty acid-containing compound in an amount of 1 to 10 parts by mass to 100 parts by mass of the base resin; and
a filler in an amount of 10 to 80 parts by mass to 100 parts by mass of the base resin;
wherein
the base resin comprises 10 to 90 mass % of a low-density polyethylene 10 to 90 mass % of a low-density polyethylene-based thermoplastic elastomer, and 0 to 80 mass % of a modified polyethylene, based on a mass of the base resin, and
the filler is composed of at least one selected from the group consisting of calcium carbonate and a silicate compound.

2. The flame-retardant resin composition according to claim 1, further comprising a hindered amine compound blended in an amount of 0.1 to 8 parts by mass to 100 parts by mass of the base resin.

3. The flame-retardant resin composition according to claim 1, wherein the content of the base resin comprises 5 mass % or more of the modified polyethylene.

4. The flame-retardant resin composition according to claim 1, wherein the base resin comprises 20 mass % or less of the modified polyethylene.

5. The flame-retardant resin composition according to claim 1,
wherein the base resin comprises 40 to 85 mass % of the low-density polyethylene, and
wherein the base resin comprises 15 to 60 mass % of the low-density polyethylene-based thermoplastic elastomer.

6. The flame-retardant resin composition according to claim 1,
wherein the silicone compound is in an amount of 3 to 12 parts by mass to 100 parts by mass of the base resin, and
wherein the fatty acid-containing compound is in an amount of 3 to 10 parts by mass to 100 parts by mass of the base resin.

7. A cable comprising:
a transmission medium composed of a conductor or an optical fiber; and
an insulator covering the transmission medium, the insulator including an insulating part composed of the flame-retardant resin composition according to claim 1.
